(19) United States
(12) Patent Application Publication
(10) Pub. No.: US 2016/0286297 A1
(43) Pub. Date: Sep. 29, 2016

(54) EARPHONE AND MOBILE TERMINAL FOR ECG DETECTION

(71) Applicant: HUIZHOU TCL MOBILE COMMUNICATION CO., LTD, Huizhou City, Guangdong (CN)

(72) Inventors: Jia WANG, Huizhou City, Guangdong (CN); Li SUN, Huizhou City, Guangdong (CN)

(21) Appl. No.: 14/891,471

(22) PCT Filed: Jan. 20, 2015
(86) PCT No.: PCT/CN2015/071086

§ 371 Date: Nov. 17, 2015

(30) Foreign Application Priority Data
Aug. 28, 2014 (CN) 201410431404.6

(51) Int. Cl. H04R 1/10

(52) U.S. Cl. CPC H04R 1/1016; H04R 1/1091; H04R 1/1041; H04R 2460/01

(57) ABSTRACT

An earphone and a mobile terminal for ECG detection are disclosed. The earphone for ECG detection includes an acquisition circuit, signal lines and an interface circuit. The signal lines connect the acquisition circuit with the interface circuit. The acquisition circuit includes at least two earplugs and at least two electrodes. At least two of the electrodes are respectively disposed in at least two of the earplugs for collecting an ECG signal. The signal lines connect the earphone connector to at least two of the earplugs, and to at least two of the electrodes. The signal lines are used for transmitting the ECG signal and an earphone signal. By the electrodes in the earplugs collecting the ECG signal, and by the signal line of the earphone transmitting the ECG signal to mobile terminal, the ECG signal can be conveniently collected, the ECG detection accuracy can be improved.

### FIELD OF THE INVENTION

The present invention relates to a mobile communication terminal, and particularly to an earphone and a mobile terminal for ECG (electrocardiography) detection.

### BACKGROUND OF THE INVENTION

With the development of mobile communication technology, mobile terminal-related application range has become wider. For example, ECG (electrocardiography) detection can be performed by a mobile terminal, and the user's ECG signals and heart rates are displayed, so that the user can understand his or her physical condition in real time.

In a current ECG detection method, two electrodes are disposed on the mobile terminal, and two of the user's fingers simultaneously hold down the two electrodes for performing the ECG detection. After the ECG detection chip detects the ECG signals from the electrodes, the detected ECG signals are transmitted to the mobile terminal, so that the mobile terminal calculates the heart rate and plots the electrocardiogram based upon the ECG signals.

Since there is a certain requirement for the contact duration of the electrodes during the ECG detection, the longer the contact duration of the electrodes is, the higher the accuracy of the ECG detection is. However, in this method, the user's fingers have to hold down the two electrodes for a period of time during the detection for performing the ECG detection. This is not convenient for the user to perform real-time ECG detection.

Furthermore, the positions of the additionally-disposed electrodes also affect the overall appearance of the mobile terminal.

### SUMMARY OF THE INVENTION

The present invention resolves the technical problem by providing an earphone and mobile terminal for EGC detection for conveniently performing the ECG detection, the ECG detection accuracy, and reducing the influence of electrodes on the appearance of the mobile terminal.

In order to resolve the aforementioned technical problems, a technical solution used in the present application is to provide an earphone for ECG detection, wherein the earphone comprises: an acquisition circuit, signal lines, and an interface circuit, the signal lines connecting the acquisition circuit with the interface circuit; the acquisition circuit comprising at least two earplugs and at least two electrodes, wherein at least two of the electrodes are respectively disposed in at least two of the earplugs for collecting an ECG signal; the interface circuit comprising an earphone connector used for being connected with a mobile terminal, wherein the signal lines are connected between the earphone connector and at least two of the earplugs, and at least two of the electrodes; the signal lines comprising a left-channel signal line, a right-channel signal line, a microphone signal line, and a ground signal line, or the signal lines further comprising a left-channel noise-canceling signal line and a right-channel noise-canceling signal line; the signal lines used for transmitting the ECG signal and an earphone signal, wherein when the signal lines comprise the left-channel signal line, the right-channel signal line, the microphone signal line, and the ground signal line, the left-channel signal line and the right-channel signal line are used for transmitting the ECG signal, and when the signal lines further comprise the left-channel noise-canceling signal line and the right-channel noise-canceling signal line, the left-channel noise-canceling signal line and the right-channel noise-canceling signal line are used for transmitting the ECG signal.

At least two of the electrodes comprise at least two pieces connected in parallel.

In order to resolve the aforementioned technical problems, a technical solution used in the present application is to provide an earphone for ECG detection, wherein the earphone comprises: an acquisition circuit, signal lines, and an interface circuit, the signal lines connecting the acquisition circuit with the interface circuit; the acquisition circuit comprising at least two electrodes and at least two earplugs, wherein at least two of the electrodes are disposed in at least two of the earplugs for collecting an ECG signal; the interface circuit comprising an earphone connector used for being connected with a mobile terminal, wherein the signal lines are connected between the earphone connector and at least two of the earplugs, and at least two of the electrodes, and the signal lines are used for transmitting the ECG signal and an earphone signal.

The signal lines comprise a left-channel signal line, a right-channel signal line, a microphone signal line, and a ground signal line, and when the earphone is being used for detecting the ECG signal, the left-channel signal line and the right-channel signal line are used for transmitting the ECG signal.

The signal lines comprise a left-channel signal line, a right-channel signal line, a microphone signal line, a ground signal line, a left-channel noise-canceling signal line, a right-channel noise-canceling signal line and when the earphone is being used for detecting the ECG signal, the left-channel noise-canceling signal line and the right-channel noise-canceling signal line are used for transmitting the ECG signal.

At least two of the electrodes comprise at least two pieces connected in parallel.

In order to resolve the aforementioned technical problems, a technical solution used in the present application is to provide a mobile terminal for ECG detection, wherein the mobile terminal comprises: an earphone interface circuit and an ECG detection circuit, which are connected with each other; the earphone interface circuit used for inputting an ECG signal from at least two electrodes in an earphone, wherein at least two of the electrodes are respectively disposed in earplugs for collecting the ECG signal; and the ECG detection circuit is used for detecting the ECG signal.

The terminal further comprises a signal switch circuit, the signal switch circuit is an alternate switch circuit including a first end, a second end, and a third end, the first end is connected to the earphone interface circuit, the second end is connected to an earphone circuit in the terminal, the third end is connected to the ECG detection circuit, and the first end is connected to the third end during the ECG detection, and otherwise the first end is connected to the second end.

The earphone interface circuit comprises a left-channel signal line, a right-channel signal line, a microphone signal line, and a ground signal line, and the first end is respectively connected to the left-channel signal line and the right-channel signal line.

The earphone interface circuit comprises a left-channel signal line, a right-channel signal line, a microphone signal line, a ground signal line, a left-channel noise-canceling signal line, a right-channel noise-canceling signal line, and the first end is respectively connected to the left-channel noise-canceling signal line and the right-channel noise-canceling signal line.

The earphone interface circuit comprises a left-channel signal line, a right-channel signal line, a microphone signal line, a ground signal line, a left-channel noise-canceling signal line, a right-channel noise-canceling signal line, and the left-channel noise-canceling signal line and the right-channel noise-canceling signal line are directly connected to the ECG detection circuit.

The terminal further comprises a control circuit and a display circuit; the control circuit used for drawing an electrocardiogram based upon the ECG signal; and the display circuit used for displaying the electrocardiogram.

The beneficial effects of the present application are that: unlike the prior art, in the present application, the ECG signal collected by the electrodes disposed in the earplugs is inputted by the earphone interface circuit for conveniently performing the ECG detection, improving the ECG detection accuracy, and reducing the influence of electrodes on the appearance of the mobile terminal.

### BRIEF DESCRIPTION OF THE DRAWINGS

FIG. 1 is a structural schematic diagram of an earphone for ECG detection in accordance with an embodiment of the present application;

FIG. 2 is a structural schematic diagram of an earphone connector in an interface circuit in accordance with an embodiment of the present application;

FIG. 3 is a structural schematic diagram of an earphone connector in an interface circuit in accordance with another embodiment of the present application;

FIG. 4 is a structural schematic diagram of a mobile terminal for ECG detection in accordance with an embodiment of the present application;

FIG. 5 is a structural schematic diagram of a mobile terminal for ECG detection in accordance with another embodiment of the present application; and

FIG. 6 is a structural schematic diagram of a mobile terminal for ECG detection in accordance with yet another embodiment of the present application.

### DETAILED DESCRIPTION OF THE PREFERRED EMBODIMENTS

For illustration, but not for limitation, specific details, such as system configurations, interfaces, and techniques, are provided for thorough understanding of the present application in the following description. However, a person of ordinary skill in the art should understand that the present application can also be achieved in other embodiments without these specific details. In other instances, the detailed description of well-known devices, circuits, and methods are omitted for preventing unnecessary details from interfering with the description of the present application.

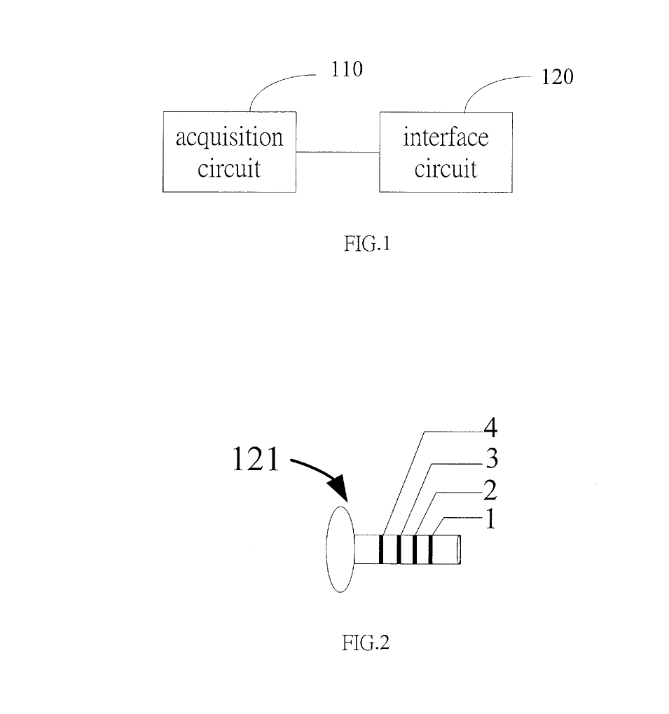

Please refer to FIG. 1, which is a structural schematic diagram in accordance with an earphone for ECG detection of an embodiment of the present application. In the present embodiment, an earphone for ECG detection includes an acquisition circuit 110 and an interface circuit 120, wherein the acquisition circuit 110 and the interface circuit 120 are connected through signal line (not shown in the FIGs.).

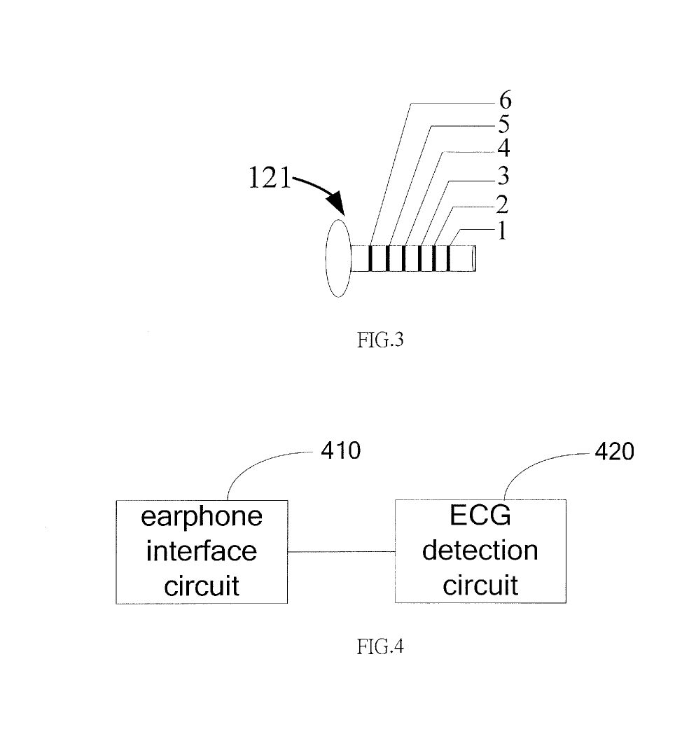

Please also refer to FIG. 2 and FIG. 3. FIG. 2 is a structural schematic diagram of an earphone connector in an interface circuit in FIG. 1 in accordance with an embodiment. FIG. 3 is a structural schematic diagram of an earphone connector in an interface circuit in FIG. 1 in accordance with another embodiment.

The acquisition circuit 110 includes at least two earplugs (not shown in the FIGs.) and at least two electrodes (not shown in the FIGs.), wherein at least two of the electrodes are disposed in at least two of the earplugs for collecting ECG signals.

The interface circuit 120 includes an earphone connector 121 for being connected with the mobile terminal, wherein the signal lines are connected between the earphone connector 121 and at least two of the earplugs (not shown), and at least two of the electrodes (not shown). The signal lines are used for transmitting the ECG signals and the earphone signals.

Alternatively, at least two of the electrodes are respectively formed by at least two pieces connected in parallel.

For example, the earphone used for detecting the ECG signals includes the acquisition circuit 110, the interface circuit 120, and the signal line. The acquisition circuit 110 and the interface circuit 120 are connected by the signal lines.

The acquisition circuit 110 includes at least two earplugs and at least two electrodes, wherein at least two of the electrodes are embedded in at least two of the earplugs. Silver chloride, stainless steel, conductive rubber, and other materials can be used as the material of the electrodes. Each electrode may be formed from a single piece, and may also be formed from multiple pieces connected in parallel, but is not limited thereto. When each electrode is formed from multiple pieces connected in parallel, the size of the electrode can be expanded, the area of the electrode contacting the user's ear can be increased, and, moreover, the impedance of the electrode itself can be reduced for improving the ECG detection accuracy.

The interface circuit 120 includes an earphone connector 121 used for being connected with a mobile terminal, wherein the signal lines are connected between the earphone connector and at least two of the earplugs, and at least two of the electrodes. The signal lines are used for transmitting the ECG signals and the earphone signals. The signal line are connected to the left earplugs and the right earplugs, thereby respectively connecting the electrodes embedded in the left earplugs and the right earplugs. It should be appreciated that the outer layer of the signal lines may be provided with shielded cables, thereby reducing interference with the ECG signals, and improving the ECG detection accuracy and reliability.

During the ECG detection, the earphone connector 121 is connected to the mobile terminal through an earphone socket, and the two electrodes respectively contact the user's left ear and right ear to collect the user's ECG signals. The collected ECG signals are transmitted to the mobile terminal through the signal lines of the earphone. It should be appreciated that the signal lines can transmit the ECG signals and the earphone signals simultaneously, or can only transmit the ECG signals during the ECG detection.

For example, if the earphone connector 123 only includes the left-channel signal line 1, the right-channel signal line 2, the microphone signal line 3, and the ground signal line 4, during the ECG detection, the left-channel signal line 1 is used for transmitting the ECG signals of the left ear collected by the electrode to the mobile terminal, and the right-channel signal line 2 is used for transmitting the ECG signals of the right ear collected by the electrode to the mobile terminal. When the ECG signals are not being detected, the left-channel signal line 1 is used for transmitting the left-channel earphone signals outputted from the mobile terminal to the left earplug, and the right-channel signal line 2 is used for transmitting the right-channel earphone signals outputted from the mobile terminal to the right earplug.

If the earphone connector 121 includes a left-channel signal line 1, a right-channel signal line 2, a microphone signal line 3, a ground signal line 4, a left-channel noise-canceling signal line 5 and a right-channel noise-canceling signal line 6, during the ECG detection, the left-channel noise-canceling signal line 5 is used for transmitting the ECG signals of the left ear collected by the electrode to the mobile terminal, and the right-channel noise-canceling signal line 6 is used for transmitting the ECG signals of the right ear collected by the electrode to the mobile terminal. When the ECG signals are not being detected, the left-channel noise-canceling signal line 5 is used to eliminate ambient noise for the left channel, and the right-channel noise-canceling signal line 6 is used to eliminate ambient noise for the right channel. It can be understood that when the ECG signals are not being detected, the left-channel noise-canceling signal line and the right-channel noise-canceling signal line may also be idle.

In the above method, the electrodes are disposed in the earplugs, the ECG signals are collected by the earplugs contacting the user's ears, and the ECG signals are transmitted to the mobile terminal through the earphone signal lines for conveniently and reliably performing the ECG detection, and for improving the ECG detection accuracy.

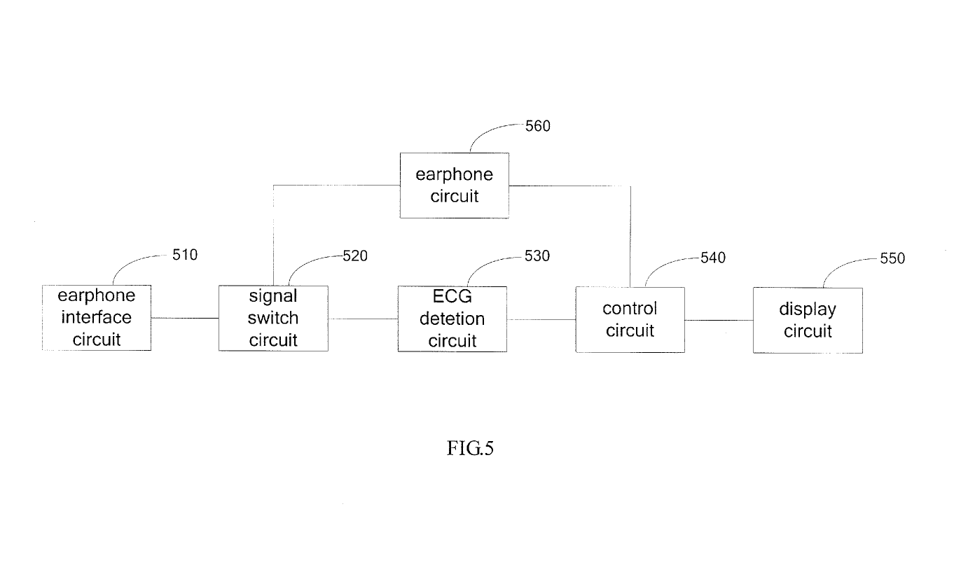

Please refer to FIG. 4, which is a structural schematic diagram of a mobile terminal for ECG detection in accordance with an embodiment of the present application. The mobile terminal for the ECG detection and the earphone for the ECG detection are used coordinately. In the present embodiment, the mobile terminal for the ECG detection includes an earphone interface circuit 410 and an ECG detection circuit 420, which are connected with each other.

The earphone interface circuit 410 is used for inputting the ECG signals from at least two of the electrodes in the earphone, wherein at least two of the electrodes are disposed in the earplugs in the earphone for collecting the ECG signals.

The ECG detection circuit 420 is used for detecting the ECG signals.

For example, when the user would like to perform the ECG detection, the user connects the earphone for the ECG detection to the mobile terminal through the earphone connector, enters the menu option of the ECG detection function of the mobile terminal, and selects the ECG detection icon, so that the earphone interface circuit 410 inputs the ECG signals collected from at least two of the electrodes of the earphone. At least two of the electrodes are disposed in the earplugs of the earphone for collecting the ECG signals. The collected ECG signals are transmitted to the earphone interface circuit 410 through the signal lines of the earphone. The earphone socket of the earphone interface circuit 410 matches the earphone connector.

The ECG detection circuit 420 detects the ECG signals inputted from the earphone interface circuit 410, so that the mobile terminal processes the detected ECG signals, and plots and displays an electrocardiogram to the user based upon the ECG signals.

When the user is not performing the ECG detection, the signal line of the earphone is used for transmitting the earphone signals.

In the above method, the ECG signals collected by the electrodes disposed in the earplugs are inputted by the earphone interface circuit for conveniently performing the ECG detection, improving the ECG detection accuracy, and reducing the influence of electrodes on the appearance of the mobile terminal.

Please refer to FIG. 5, which is a structural schematic diagram of a mobile terminal for ECG detection in accordance with another embodiment of the present application. The difference from the previous embodiment is that the mobile terminal for the ECG detection further includes a signal switch circuit 520, a control circuit 540, a display circuit 550, and an earphone circuit 560 in the present embodiment. The earphone interface circuit 510, the signal switch circuit 520, the ECG detection circuit 530, the control circuit 540, and the display circuit 550 are connected in sequence. The earphone circuit 560 is connected between the signal switch circuit 520 and the control circuit 540.

The earphone interface circuit 510 is used for inputting the ECG signals from at least two of the electrodes in the earphone, wherein at least two of the electrodes are disposed in the earplugs of the earphone for collecting the ECG signals.

The signal switch circuit is an alternate switch circuit including a first end, a second end, and a third end. The first end is connected to the earphone interface circuit 510, the second end is connected to an earphone circuit 560 in the terminal, and the third end is connected to the ECG detection circuit 530. The first end is connected to the third end during the ECG detection. Otherwise, the first end is connected to the second end.

The ECG detection circuit 530 is used for detecting the inputted ECG signals.

The control circuit 540 is used for plotting the electrocardiogram based upon the detected ECG signals.

The display circuit 550 is used for displaying the electrocardiogram.

For example, after the earphone for the ECG detection is connected to the mobile terminal through the earphone connector, under normal circumstances, the control circuit 540 controls the signal switch circuit 520 to connect the first end to the second end in default, so as to connect the earphone interface circuit 510 to the earphone circuit 560, so that the earphone circuit 560 transmits the earphone signals to the earphone interface circuit 510 through the signal switch circuit 520.

When a user would like to perform the ECG detection, the user enters the menu option of the ECG detection function of the mobile terminal, and selects the ECG detection icon. After receiving the request for the ECG detection sent by the user, the control circuit 540 connects the first end to the third end in the signal switch circuit 520 by controlling the chip select signals of the signal switch circuit 520, so as to connect the earphone interface circuit 510 to the ECG detection circuit 530.

The ECG detection circuit 530 detects the ECG signals, which are inputted by the earphone interface circuit 510 and collected by at least two of the electrodes in the earphone. At least two of the electrodes are disposed in the earplugs of the earphone for collecting the ECG signals. The collected ECG signals are transmitted to the earphone interface circuit 510 through the signal lines of the earphone. The earphone socket of the earphone interface circuit 510 matches the earphone connector.

For example, if the earphone connector 121 only includes the left-channel signal line 1, the right-channel signal line 2, the microphone signal line 3, and the ground signal line 4, the signal lines included in the earphone socket of the earphone interface circuit 510 match them.

During the ECG detection, the first end is respectively connected to the left-channel signal line 1 and the right-channel signal line 2, the left-channel signal line 1 transmits the ECG signals of the left ear collected by the electrode to the mobile terminal, and the right-channel signal line 2 transmits the ECG signals of the right ear collected by the electrode to the mobile terminal.

When the ECG signals are not being detected, the left-channel signal line 1 transmits the left-channel earphone signals outputted from the mobile terminal to the left earplug, and the right-channel signal line 2 transmits the right-channel earphone signals outputted from the mobile terminal to the right earplug.

For example, if the earphone connector 121 includes the left-channel signal line 1, the right-channel signal line 2, the microphone signal line 3, the ground signal line 4, the left-channel noise-canceling signal line 5, and the right-channel noise-canceling signal line 6, the signal lines included in the earphone socket of the earphone interface circuit 510 match them.

During the ECG detection, the first end is respectively connected to the left-channel noise-canceling signal line 5 and the right-channel noise-canceling signal line 6, the left-channel signal line 1 transmits the left-channel earphone signals outputted from the mobile terminal to the left earplugs, the right-channel signal line 2 transmits the left-channel earphone signals outputted from the mobile terminal to the right earplugs, the left-channel noise-canceling signal line 5 transmits the ECG signals of the left ear collected by the electrode to the mobile terminal, and the right-channel noise-canceling signal line 6 transmits the ECG signals of the right ear collected by the electrode to the mobile terminal.

When the ECG signals are not being detected, the left-channel signal line 1 transmits the left-channel earphone signals outputted from the mobile terminal to the left earplug, the right-channel signal line 2 transmits the right-channel earphone signals outputted from the mobile terminal to the right earplug, the left-channel noise-canceling signal line 5 is used to eliminate ambient noise for the left channel, and the right-channel noise-canceling signal line 6 is used to eliminate ambient noise for the right channel. It can be understood that in this ease, the signal lines of the earphone can not only transmit the audio signals, but may also transmits the ECG signals, that is, the user can perform the ECG detection while listening to audio files, and test the effect of listening to the current audio file on user's heart rate and other data, so as to adjust the audio file based upon the heart rate and other data.

The ECG detection circuit 530 communicates with the control circuit 540, and transmits the detected ECG signals to the control circuit 540, wherein the communication protocol is not limited herein, and can be the serial communication protocol or the I2C communication protocol.

When the control circuit 540 receives the ECG signals, the ECG signal control circuit 540 processes the received ECG signals, filters the ECG signals, resolves the ECG data from the original ECG signals, plots the electrocardiogram based upon the ECG data, and controls the display circuit 550 to display the electrocardiogram to the user.

In the above method, by the earphone interface circuit inputting the ECG signals collected by the electrodes disposed in the earplugs, and by the signal switch circuit switching to transmit the earphone signals or the ECG signals, the ECG detection is conveniently and reliably performed, the ECG detection accuracy is improved, and the influence of electrodes on the appearance of the mobile terminal is reduced.

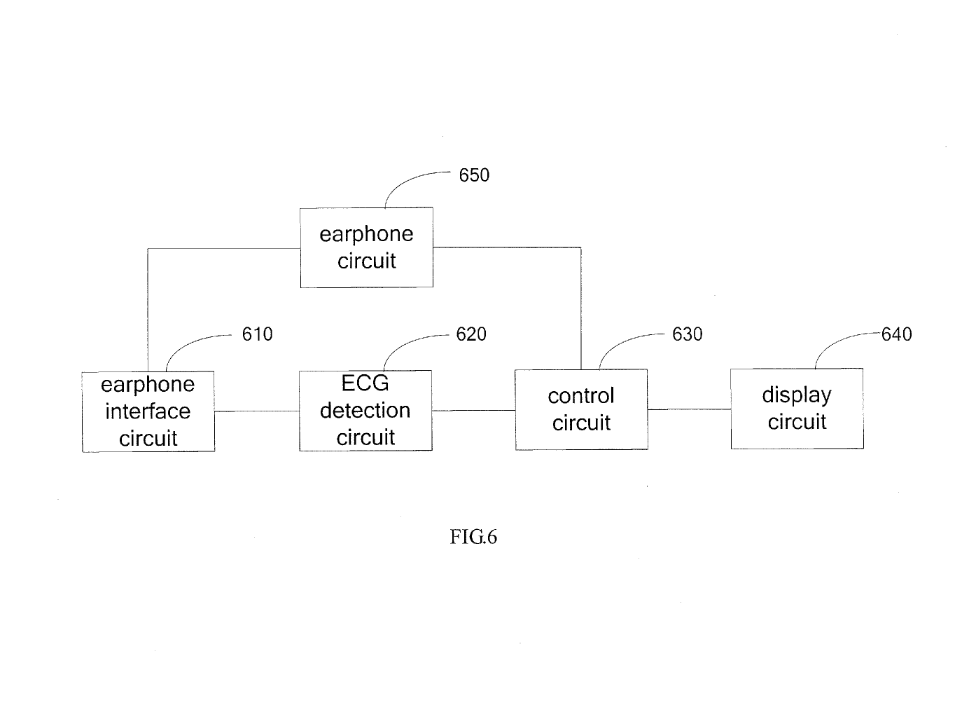

Please refer to FIG. 6, which is a structural schematic diagram of a mobile terminal for ECG detection in accordance with yet another embodiment of the present application. In the present embodiment, the earphone coordinately used with the mobile terminal for the ECG detection includes an idle signal line in addition to the transmission of the earphone signals. The difference from the previous embodiment is that the signal switch circuit 520 is omitted in the mobile terminal in the present embodiment, and the mobile terminal includes an earphone interface circuit 610, an ECG detection circuit 620, a control circuit 630, a display circuit 640, and an earphone circuit 650. The earphone interface circuit 610, the ECG detection circuit 620, the control circuit 630, and the display circuit 640 are connected in sequence. The earphone circuit 650 is connected between the earphone interface circuit 610 and the control circuit 630.

The earphone interface circuit 610 is used for inputting the ECG signals from at least two of the electrodes in the earphone, wherein at least two of the electrodes are disposed in the earplugs of the earphone for collecting the ECG signals.

The ECG detection circuit 620 is used for detecting the inputted ECG signals.

The control circuit 630 is used for plotting the electrocardiogram based upon the detected ECG signals and controlling the earphone circuit 650 to transmit the earphone signals to the earphone interface circuit 640.

The display circuit 640 is used for displaying the electrocardiogram.

For example, after the earphone for the ECG detection is connected to the mobile terminal through the earphone connector, under normal circumstances, the control circuit 630 controls the earphone circuit 650 to transmit the earphone signals to the earphone interface circuit 610.

When a user would like to perform the ECG detection, the user enters the menu option of the ECG detection function of the mobile terminal and selects the ECG detection icon. After receiving the request for the ECG detection sent by the user, the control circuit 540 requests the ECG detection circuit 620 to detect the ECG signals, which are inputted by the earphone interface circuit 510 and collected by at least two of the electrodes in the earphone. At least two of the electrodes are disposed in the earplugs of the earphone for collecting the ECG signals. The collected ECG signals are transmitted to the earphone interface circuit 610 through the signal lines of the earphone. The earphone socket of the earphone interface circuit 610 matches the earphone connector.

For example, if the earphone connector 121 includes the left-channel signal line 1, the right-channel signal line 2, the microphone signal line 3, the ground signal line 4, the left-channel noise-canceling signal line 5, and the right-channel noise-canceling signal line 6, and the left-channel noise-canceling signal line 5 and the right-channel noise-canceling signal line 6 are idle (e.g. having no specific function), the signal lines included in the earphone socket of the earphone interface circuit 610 match them. Moreover, the left-channel signal line 1 and the right-channel signal line 2 are connected to the earphone circuit 650, the left-channel noise-canceling signal line 5 and the right-channel noise-canceling signal line 6 are connected to the ECG detection circuit 620, and the left-channel noise-canceling signal line 5 and the right-channel noise-canceling signal line 6 are specifically used for transmitting the ECG signals.

It should be understood that in the present embodiment, the signal lines of the earphone used for transmitting the ECG signals are not limited to the left-channel noise-canceling signal line and the right-channel noise-canceling signal line, and can also be defined as other idle signal lines.

During the ECG detection, the left-channel noise-canceling signal line 5 transmits the ECG signals of the left ear collected by the electrode to the mobile terminal, the right-channel noise-canceling signal line 6 transmits the ECG signals of the right ear collected by the electrode to the mobile terminal, the left-channel signal line 1 transmits the left-channel earphone signals outputted from the mobile terminal to the left earplugs, and the right-channel signal line 2 transmits the left-channel earphone signals outputted from the mobile terminal to the right earplugs.

When the ECG signals are not being detected, the left-channel signal line 1 transmits the left-channel earphone signals outputted from the mobile terminal to the left earplug, and the right-channel signal line 2 transmits the right-channel earphone signals outputted from the mobile terminal to the right earplug, the left-channel noise-canceling signal line 5 is used to eliminate ambient noise for the left channel, and the right-channel noise-canceling signal line 6 is used to eliminate ambient noise for the right channel. It can be understood that in this case, the signal lines of the earphone can not only transmit the audio signals, but may also transmits the ECG signals, that is, the user can perform the ECG detection while listening to the audio file, and test the effect of listening to the current audio on user's heart rate and other data, so as to adjust the audio file based upon the heart rate and other data.

The ECG detection circuit 620 communicates with the control circuit 630, and transmits the detected ECG signals to the control circuit 630, wherein the communication protocol is not limited here, which can be the serial communication protocol or the I2C communication protocol.

When the control circuit 630 receives the ECG signals, the ECG signal control circuit 630 processes the received ECG signals, filters the ECG signals, resolves the ECG data from the original ECG signals, plots the electrocardiogram based upon the ECG data, and controls the display circuit 640 to display the electrocardiogram to the user.

In the above method, by the earphone interface circuit inputting the ECG signals collected by the electrodes disposed in the earplugs, and by the idle earphone signal lines used for transmitting the ECG signals during the normal transmission of the earphone signals, the ECG detection is conveniently and reliably performed without interfering with the transmission of the earphone signals, the ECG detection accuracy is improved, and the influence of electrodes on the appearance of the mobile terminal is reduced.

For illustration, but not for limitation, specific details, such as system configurations, interfaces, and techniques, are provided for thorough understanding of the present application in the following description. However, a person of ordinary skill in the art should understand that the present application can also be achieved in other embodiments without these specific details of. In other instances, the detailed description about well-known devices, circuits, and methods are omitted for preventing unnecessary details from impeding the description of the present application.

What is claimed is:

1. (canceled)

2. (canceled)

3. An earphone for a mobile terminal for ECG detection, comprising:
an acquisition circuit having at least two electrodes and at least two earplugs, wherein at least two of the electrodes are disposed in at least two of the earplugs for collecting an ECG signal,
an interface circuit having an earphone connector used for being connected with the mobile terminal, and
signal lines connecting the acquisition circuit with the interface circuit, and connecting the earphone connector to at least two of the earplugs, and to at least two of the electrodes for transmitting the ECG signal and an earphone signal, wherein either a left-channel signal line and a right-channel signal line or a left-channel noise-canceling signal line and a right-channel noise-canceling signal line are used for transmitting the ECG signal during the ECG detection.

4. (canceled)

5. (canceled)

6. The earphone as claimed in claim 3, wherein at least two of the electrodes respectively include at least two pieces connected in parallel.

7. A mobile terminal for ECG detection, comprising:
an earphone interface circuit for inputting an ECG signal from at least two electrodes in an earphone, wherein at least two of the electrodes are respectively disposed in earplugs for collecting the ECG signal;
an ECG detection circuit connected with the earphone interface circuit, for detecting the ECG signal; and
a signal switch circuit, which is an alternate switch circuit including a first end, a second end and a third end, wherein the first end is connected to the earphone interface circuit, the second end is connected to an earphone circuit in the terminal, and the third end is connected to the ECG detection circuit, wherein the first end is configured to connect the third end during the ECG detection, and connect to the second end when the ECG detection is not being performed.

8. (canceled)

9. The terminal as claimed in claim 7, wherein the first end is connected to either a left-channel signal line and a right-channel signal line or a left-channel noise-canceling signal line and a right-channel noise canceling signal line.

10. (canceled)

11. A mobile terminal for ECG detection, comprising:
an earphone interface circuit for inputting an ECG signal from at least two electrodes in an earphone, wherein at least two of the electrodes are respectively disposed in earplugs for collecting the ECG signal; and
an ECG detection circuit connected with the earphone interface circuit, for detecting the ECG signal; wherein the left-channel noise-canceling signal line and the right-channel noise-canceling signal line are directly connected to the ECG detection circuit.

12. The terminal as claimed in claim 7, further comprising;
a control circuit used for drawing an electrocardiogram based upon the ECG signal; and
a display circuit used for displaying the electrocardiogram.

13. The terminal as claimed in claim 11 further comprising
a control circuit used for drawing an electrocardiogram based upon the ECG signal; and a
display circuit used for displaying the electrocardiogram.
